(19) United States
(12) Patent Application Publication
(10) Pub. No.: US 2015/0317779 A1
(43) Pub. Date: Nov. 5, 2015

(54) IMAGE PROCESSING SYSTEM, IMAGE PROCESSING METHOD, AND COMPUTER PROGRAM PRODUCT

(71) Applicants: Shimpei SONODA, Kanagawa (JP); Akihiro MATSUOKA, Kanagawa (JP); Hideki SUGIMOTO, Kanagawa (JP)

(72) Inventors: Shimpei SONODA, Kanagawa (JP); Akihiro MATSUOKA, Kanagawa (JP); Hideki SUGIMOTO, Kanagawa (JP)

(73) Assignee: Ricoh Company, Limited, Tokyo (JP)

(21) Appl. No.: 14/700,271

(22) Filed: Apr. 30, 2015

(30) Foreign Application Priority Data
May 2, 2014 (JP) 2014-095086

(51) Int. Cl. G06T 7/00; G06K 9/34; G06K 9/46; G06K 9/36; G06T 7/60; G06T 5/00

(52) U.S. Cl. CPC G06T 7/001; G06T 7/0044; G06T 7/003; G06T 7/0083; G06T 7/608; G06T 5/006; G06K 9/4633; G06K 9/36; G06K 9/34; G06T 2207/10004; G06T 2207/10028; G06T 2207/30144; G06T 2207/30108; G06T 2207/30168; G06K 2009/363; G06K 2209/01

(57) ABSTRACT

An image processing system includes an imaging device, an angle detecting unit, a relative angle calculating unit, and a relative angle correcting unit. The imaging device captures an image of an object to be inspected. The angle detecting unit detects an angle of the imaging device. The relative angle calculating unit calculates a relative angle between the object to be inspected and the imaging device. The relative angle correcting unit corrects a tilt indicated by the relative angle calculated by the relative angle calculating unit.

### CROSS-REFERENCE TO RELATED APPLICATIONS

The present application claims priority to and incorporates by reference the entire contents of Japanese Patent Application No. 2014-095086 filed in Japan on May 2, 2014.

### BACKGROUND OF THE INVENTION

1. Field of the Invention

The present invention relates to an image processing system, an image processing method, and a computer program product used for label inspection, appearance inspection, and the like.

2. Description of the Related Art

Inspection apparatuses using an imaging device such as a camera have recently been used for label inspection or appearance inspection in a factory and the like. Such apparatuses often employ pattern matching as a method for automatically performing the inspection.

In pattern matching, an image to be inspected, which is a captured image of an object to be inspected, and master pattern data prepared in advance are compared to determine a difference between features of the patterns for inspection.

If the imaging device is not fixed, the object to be inspected is not necessarily captured without a tilt with respect to the camera. Thus, a method of repeating tilt correction on the image to be inspected in an asymptotic manner and performing matching with the master pattern data for pattern matching has already been known.

Japanese Laid-open Patent Publication No. 2006-245726 describes a digital camera that corrects afterward an image captured by the camera in a tilted orientation. The digital camera described in Japanese Laid-open Patent Publication No. 2006-245726 includes imaging means having an imaging surface on which a plurality of photoelectric conversion elements are arranged, means for detecting an angle of the imaging surface with respect to a reference orientation, and processing means for correcting an image as much as the detected angle.

According to the conventional pattern matching method, the tilt of the image to be inspected is repeatedly corrected in an asymptotic manner, and matching is performed between the image to be inspected and the master pattern data each time the correction is repeated. The processing time for matching therefore increases as the tilt increases.

Since a relative tilt between the object to be inspected and the imaging device is unknown, there has been a problem that the number of repetitions before the determination of a matching failure is not predictable in advance and the number of repetitions increases.

The digital camera described in Japanese Laid-open Patent Publication No. 2006-245726 does not take account of the tilt of an object, but is predicated on that the object is not tilted. The foregoing problem therefore cannot be solved if the digital camera is used for the pattern matching.

Therefore, there is a need for an image processing system that are capable of performing tilt correction for pattern matching in a short time.

### SUMMARY OF THE INVENTION

It is an object of the present invention to at least partially solve the problems in the conventional technology.

According to an embodiment, an image processing system includes an imaging device, an angle detecting unit, a relative angle calculating unit, and a relative angle correcting unit. The imaging device captures an image of an object to be inspected. The angle detecting unit detects an angle of the imaging device. The relative angle calculating unit calculates a relative angle between the object to be inspected and the imaging device. The relative angle correcting unit corrects a tilt indicated by the relative angle calculated by the relative angle calculating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an image processing system according to a first embodiment of the present invention;

FIG. 2 is a diagram illustrating an operation of the image processing system according to the first embodiment of the present invention;

FIGS. 3A to 3C are diagrams illustrating an image processing method according to the first embodiment of the present invention;

FIGS. 4A to 4C are diagrams illustrating a conventional image processing method;

FIG. 5 is a flowchart illustrating the operation of the image processing system according to the first embodiment of the present invention;

FIG. 6 is a diagram illustrating an operation of an image processing system according to a second embodiment of the present invention;

FIGS. 7A to 7D are diagrams illustrating an image processing method according to the second embodiment of the present invention;

FIGS. 8A to BE are diagrams illustrating the conventional image processing method; and

FIG. 9 is a flowchart illustrating the conventional image processing method.

### DETAILED DESCRIPTION OF THE PREFERRED EMBODIMENTS

### First Embodiment

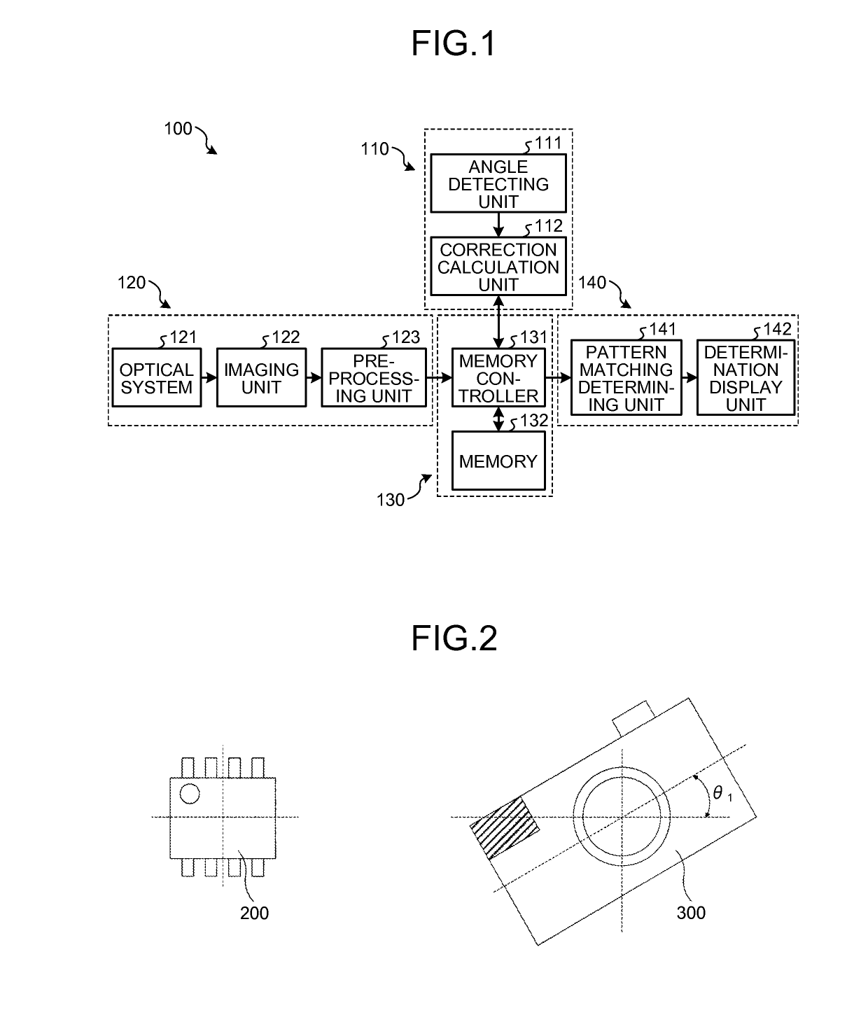

A configuration of a first embodiment will be described with reference to FIG. 1. An image processing system 100 functions as an inspection apparatus using image processing. The image processing system 100 includes a tilt correction unit 110, an image acquisition unit (an imaging device) 120, a memory control unit 130, and a determining unit 140.

The tilt correction unit 110 includes an angle detecting unit 111 to detect a tilt of an imaging surface with respect to a reference position, and a correction calculation unit 112. The correction calculation unit 112 corrects the tilt as much as an angle detected by the angle detecting unit 111. Examples of the angle detecting unit 111 may include an acceleration sensor and a gyro sensor.

The image acquisition unit 120 includes an optical system 121, an imaging unit 122 including an array of optical conversion elements, and a preprocessing unit 123. The memory control unit 130 includes a memory controller 131 and a memory 132.

The determining unit 140 includes a pattern matching determining unit 141 and a determination display unit 142. The pattern matching determining unit 141 determines whether a processed image matches a master pattern.

A conventional image processing method will be described with reference to FIGS. 8A to 8E. FIG. 8A illustrates master pattern data 200A. A captured image 200B is in a state illustrated in FIG. 8B due to tilts of an imaging device and an object to be inspected. Pattern matching with the master pattern data 200A is performed with gradual tilt corrections. Such operations are repeated until a match occurs. A known method may be used for pattern matching.

For example, a method for pattern matching may include comparing the master pattern data 200A, i.e., a template with the captured image in units of one pixel while shifting the master pattern data 200A pixel by pixel.

A more efficient method for pattern matching is described in Japanese Laid-open Patent Publication No. 63-211474. More specifically, the method includes performing matching step by step by using a plurality of template areas having different sizes, and changing the resolutions of a template area and an input image so that the amounts of data processed in the respective steps become constant.

The foregoing pattern matching methods are just an example. The method for pattern matching according to the present embodiment is not limited to such methods. Any method may be employed as long as the method includes checking whether the captured image matches the master pattern data 200A, i.e., a template.

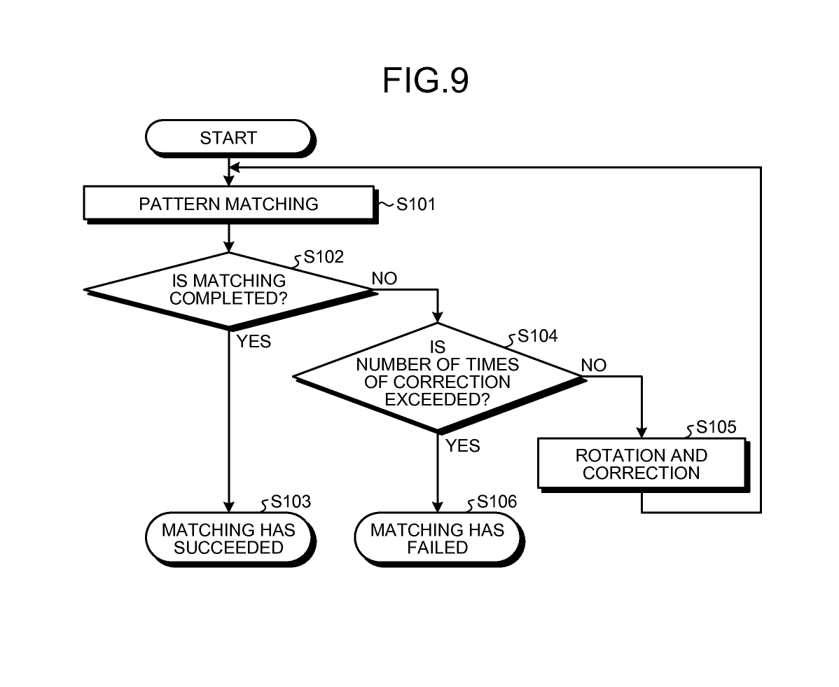

FIG. 9 is a flowchart illustrating the conventional image processing method. Initially, matching between a target image and the master pattern data is performed (step S101). If the target image matches the master pattern data (step S102, Yes), correction is completed as the matching has succeeded (step S103).

If the target image does not match the master pattern data (step S102, No), whether the number of times of correction so far exceeds a preset predetermined number of times of correction is initially checked (step S104). If the predetermined number of times of correction is exceeded (step S104, Yes), the correction is completed as the matching has failed (step S106).

If the number of times of correction does not exceed the predetermined number of times of correction (step S104, No), rotation and correction are performed further (step S105), followed by matching. For example, in the case of two-dimensional correction, the maximum number of times of rotation and correction is as many times as needed for a rotation of 360°.

FIG. 2 illustrates an object machine 200 serving as an object to be inspected when performing image capturing, and an imaging device 300. As illustrated in FIG. 2, the object machine 200 is fixed to an inspection table or the like (an object fixing unit), whereby the tilt 61 of the object machine 200 with respect to a reference axis is fixed (set to be constant). The angle set here is notified to a relative angle calculating unit.

Further, the tilt of the imaging device 300 that is not fixed with respect to the reference axis is obtained by the angle detecting unit 111. A relative tilt between the object machine 200 serving as the object to be inspected and the imaging device 300 is calculated from the foregoing two pieces of tilt information. The correction calculation unit 112 may have the function of the relative angle calculating unit.

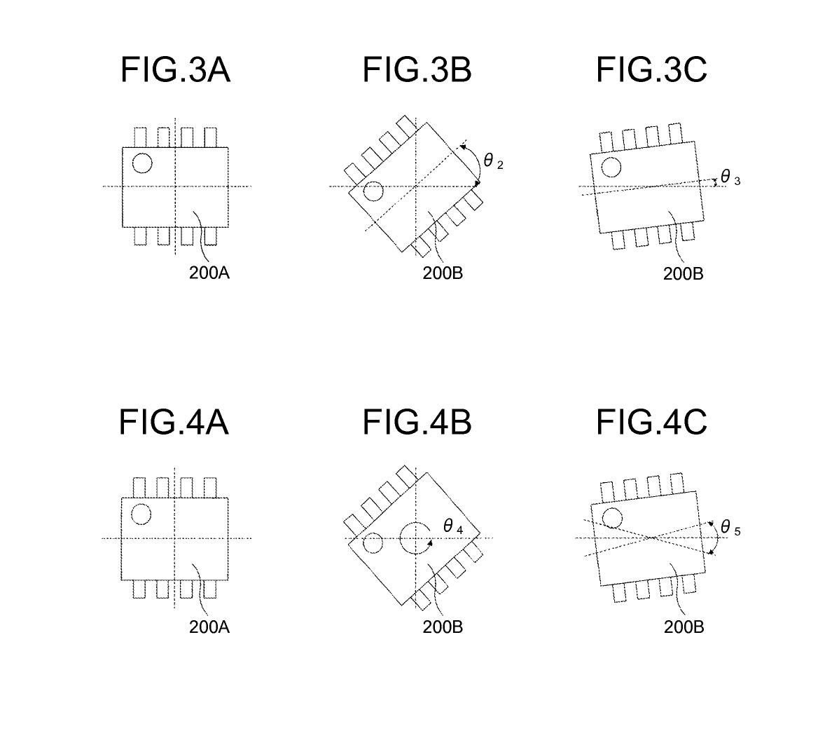

FIGS. 3A to 3C are diagrams illustrating an image processing method according to the first embodiment. In the first embodiment, the tilt of the object to be inspected with respect to the reference axis is known in advance. The angle detecting unit 111 mounted on the imaging device obtains the tilt of the imaging device with respect to the reference axis.

As illustrated in FIG. 3B, a relative angle θ₂ between the object to be inspected and the imaging device is calculated from the tilt information, and the value is set as an initial value. Then, tilt correction can be performed to complete angle correction by only the first initial correction.

Note that as illustrated in FIG. 3C, the angle correction may fail to be completed by only the first correction because of errors such as an error of the angle detecting unit and a deviation of the reference axis of the object to be inspected. In such a case, asymptotic correction is performed after the initial correction. Even in such a case, the relative tilt θ₃ between the master pattern data and the image resulting from the first correction is smaller than when the initial correction by the angle detecting unit is not used. The number of times of correction until completion of matching with the master pattern data can thus be reduced.

FIG. 4A illustrates the master pattern data 200A. As illustrated in FIG. 4B, if the image processing method of the first embodiment is not applied, a rotation up to the range indicated by θ₄, i.e., 360° is needed. In contrast, if the image processing method of the first embodiment is applied as described above, the range in which correction for matching is performed can be limited to the range indicated by θ₅ as illustrated in FIG. 4C. This can reduce the time to complete matching.

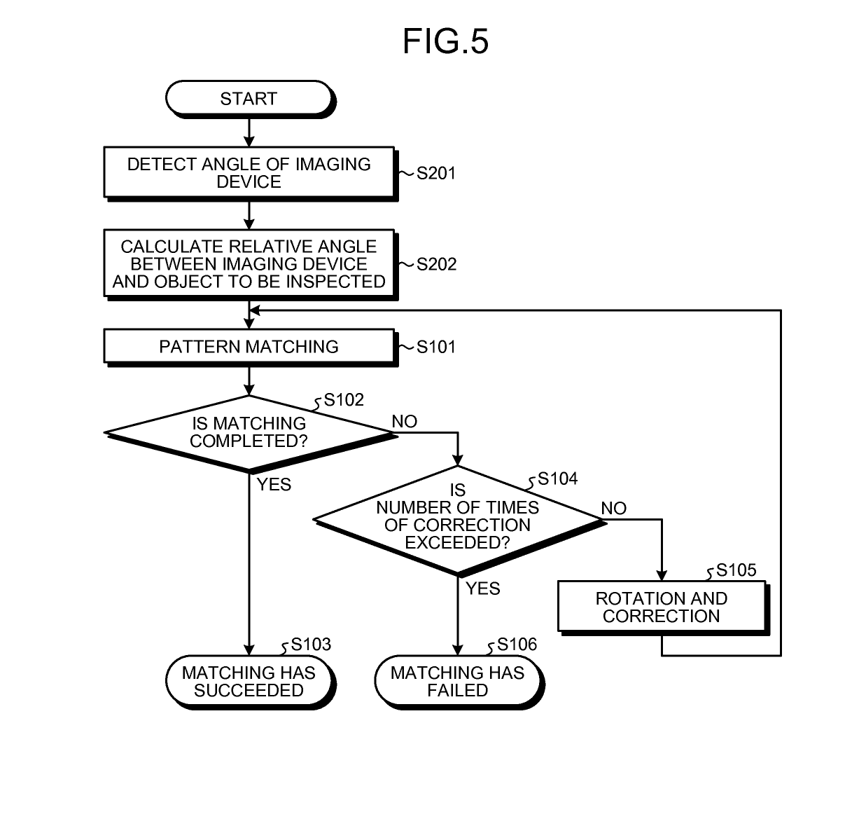

FIG. 5 is a diagram illustrating the operation of the first embodiment in the form of a flowchart. The operation illustrated in steps S101 to S106 of FIG. 5 is the same as that illustrated in FIG. 9 described above. The operation illustrated in FIG. 5 differs from that illustrated in FIG. 9 in that the angle of the imaging device is detected (step S201) before matching. The relative angle between the imaging device and the object to be inspected is calculated on the basis of the detected angle of the imaging device and the known angle of the object to be inspected (step S202).

### Second Embodiment

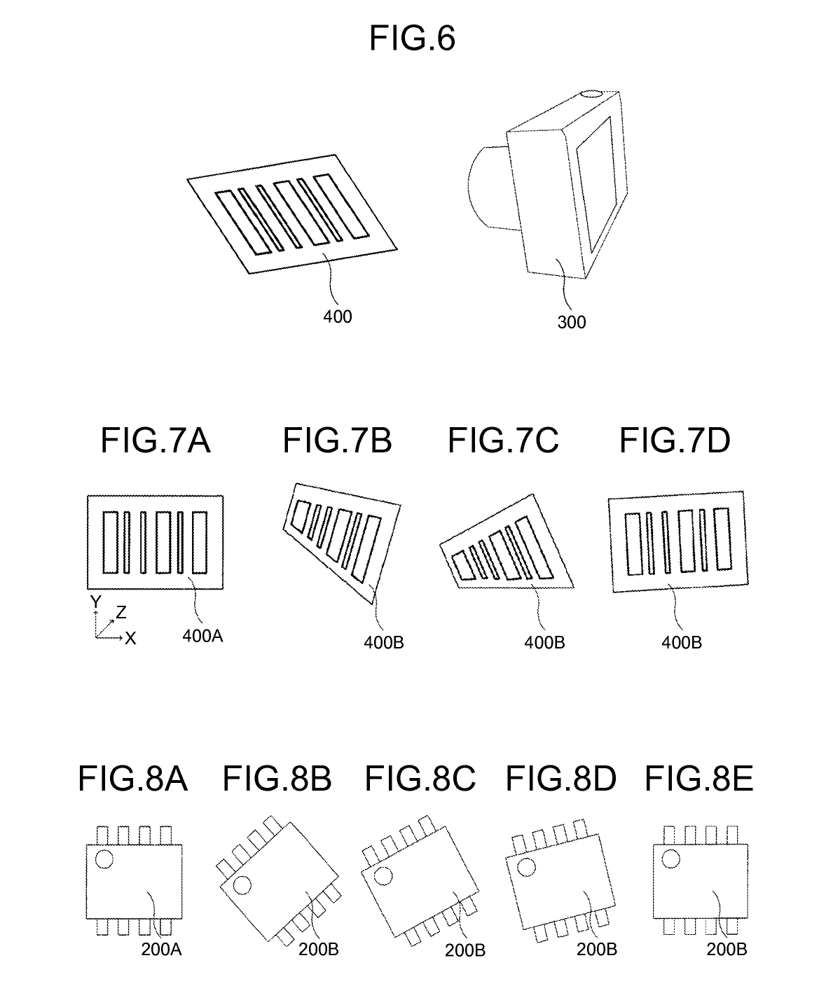

In a second embodiment, as illustrated in FIG. 6, a bar code may be used as an object to be inspected. In such a case, the tilt angle of a bar code 400 is known in advance. As illustrated in FIGS. 7A to 7D, the tilt needs to be corrected in three-dimensional directions.

FIG. 7A illustrates master pattern data 400A. A captured image 400B is in a state illustrated in FIG. 7B. In the second embodiment, the imaging device 300 is not fixed. The captured original data of the object to be inspected therefore tilts in three-dimensional directions. Tilt information about the imaging device with respect to reference axes is obtained from a gyro sensor which is built in the imaging device 300 as the angle detecting unit. A relative angle between the bar code 400 and the imaging device 300 is calculated from the tilt information.

Using this relative angle information, rotation in X-and Y-directions and trapezoidal distortion correction in a Z-axis direction can be performed to complete rough correction. This can reduce the processing time for a pattern match and determination time for a matching failure. A known method may be used as a trapezoidal distortion correction method.

For example, a method described in Japanese Laid-open Patent Publication No. 2011-33930 may be employed as the trapezoidal distortion correction method. In the method, the user presses up, down, left, and right buttons of a projector main body or the like to adjust distortion in a trapezoidal manner. A method in which the user presses the up, down, left, and right buttons to specify a desired vertex and adjust the position of the vertex among four vertexes of the image may be used. Such adjustments may be automatically performed.

For example, a program for performing image processing by the method used in the first embodiment may be installed in an image processing apparatus in advance as an image processing program. The image processing program may be installed in the image processing apparatus via a recording medium such as a CD-ROM or a transmission medium such as the Internet.

According to the present invention, an image processing system that performs tilt correction processing for pattern matching in a short time can be provided.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing system comprising:
an imaging device to capture an image of an object to be inspected;
an angle detecting unit to detect an angle of the imaging device;
a relative angle calculating unit to calculate a relative angle between the object to be inspected and the imaging device; and
a relative angle correcting unit to correct a tilt indicated by the relative angle calculated by the relative angle calculating unit.

2. The image processing system according to claim 1, further comprising an error correcting unit to correct, using pattern matching, an error that is left uncorrected by the relative angle correcting unit.

3. The image processing system according to claim 1, further comprising:
an object fixing unit to fix an angle of the object to be inspected so that the angle is set to be constant; and
an object angle notifying unit to notify the relative angle calculating unit about the set angle as a known value.

4. The image processing system according to claim 1, wherein the angle detecting unit detects the angle of the imaging device by using a gyro sensor that is built in the imaging device.

5. An image processing method comprising:
capturing an image of an object to be inspected by using an imaging device;
detecting an angle of the imaging device;
calculating a relative angle between the object to be inspected and the imaging device; and
correcting a tilt indicated by the relative angle calculated in the calculating.

6. A computer program product comprising a computer-readable medium containing an image processing program that causes a computer to execute:
capturing an image of an object to be inspected by using an imaging device;
detecting an angle of the imaging device;
calculating a relative angle between the object to be inspected and the imaging device; and
correcting a tilt indicated by the relative angle calculated in the calculating.
